(19) United States
(12) Patent Application Publication
(10) Pub. No.: US 2021/0212292 A1
(43) Pub. Date: Jul. 15, 2021

(54) HOLDING AREA AND METHOD EXECUTED IN A HOLDING AREA

(71) Applicant: DELAVAL HOLDING AB, Tumba (SE)

(72) Inventor: Anders UMEGÅRD, Tumba (SE)

(21) Appl. No.: 17/058,511

(22) PCT Filed: May 21, 2019
(86) PCT No.: PCT/SE2019/050463

§ 371 Date: Nov. 24, 2020

(30) Foreign Application Priority Data
May 24, 2018 (SE) 1850623-8

(51) Int. Cl. A01K 29/00; A01K 1/12; A01K 1/00

(52) U.S. Cl. CPC A01K 29/005; A01K 1/0017; A01K 1/123

(57) ABSTRACT

A holding area and method executed in the holding area arranged at a milking parlor of a farm are provided. A Location System is arranged at the holding area, and is configured to monitor animal movements in at least two directions. The Location System includes a controller, a tag, and transceivers configured to detect signals emitted by the tag, and communicate information with the controller. The method includes determining an arrival time of the animal and/or animal movement, identifying the animal, monitoring a waiting time of the animal in the holding area and/or animal movements of the animal, comparing the waiting time and/or animal movements with a respective reference threshold; and triggering an action, when the reference threshold is exceeded.

### TECHNICAL FIELD

This document discloses a method and a holding area comprising a system. More particularly, the holding area is arranged at a milking parlour of a farm, wherein a system is arranged at the holding area, and is configured to monitor animal movements in at least two directions.

### BACKGROUND

In an agricultural environment wherein milk is extracted from animals, such as on a dairy farm, the animals may be kept in a holding area, before they are allowed to enter a milking parlour, where milk is extracted.

Animals may have a walking order towards the milking parlour, which may differ from the milking order among the animals in the herd; or simply arrive at the holding area in an arbitrary order. The animals may require to spend some brief time in the holding area to prepare themselves for the milking and sorting out the positioning for entering the milking parlour. However, it is undesired that the animals stay in the holding area too long.

The holding area typically has a concrete floor and usually does not present any comfort allowing the animal to lay down and rest. Further, there is usually no water or fodder available in the holding area. Spending too long time at the holding area is for these reasons unhealthy for the animal, and the milk yield of the animal may be affected. Also, the health of the animal may be affected, e.g. by having to stand up too long on the concrete floor. It would therefore be desired to avoid that any animal stay too long in the holding area.

The holding area may sometimes, however not necessarily, have a moveable crowd gate for encouraging the animals to move within the holding area, towards the milking parlour in order to get milked. This may shorten the time any animal remains in the holding area; however, the crowd gate cannot move too fast as it may stress and/or hurt the animals.

Also, the animals are social creatures, interacting with each other and influencing each other in different ways. The animals react individually on different deviations from the daily life, such as e.g. a new employee at the farm. Some animals may become very stressed and upset while other animals seem to not take any notice at all.

The social interaction between the animals comprises internal ranking between the animals of the herd, and a continuous uphold of the ranking. This means that a low-rank animal that enters holding area early may be passed by other animals, thereby extending the waiting time of the low-rank animal before it is allowed to enter the milking parlour and be milked. In a worse-case scenario, the low-ranked animal never is enabled to enter the milking parlour as other more dominant animals sneak in before her. Thereby, the milk extraction of the low-ranked animal is affected. In case she is not milked in time, the animal may have problems with the milk production, which may decline.

It would for these reasons be desired to find a way to ascertain that no animal has to remain too long in the waiting area, as the milk yield as well as the health of the animal may be affected.

Another possible problem at a farm is to identify deviant animals, such as ill or injured animals, or animals in heat. Several attempts have been made for this purpose, for example based on measurement and analysis of milk yield, activity, rumination, milk composition, hormones, etc. However, they all have their limitations and/or disadvantages. It may for this reason be desired to find another methodology to identify the deviant animal, to be utilised alone, or in combination with other measurements, and find a way to ascertain that she does not stay too long in the holding area, due to her odd behaviour.

At some farms, the animals are divided into different milking groups, inter alia based on internal ranking among the animals, in order to avoid the above described scenario of low-ranked animals being prevented from entering the milking parlour by other animals.

To sort out low-ranked animals from different milking groups and put them in a separate low-ranked animal group is traditionally made manually by the farmer based on observations and experience. However, as the farmer also has other challenging tasks, it would be desired to find a manner to reduce the labour of the farmer, for example by simplifying the ranking and sorting of animals.

### SUMMARY

It is therefore an object of this invention to solve at least some of the above problems and improve the milking process of animals at a farm.

According to a first aspect of the invention, this objective is achieved by a holding area arranged at a milking parlour of a farm, wherein a Real-Time Location System (RTLS) is arranged at the holding area. The RTLS is configured to monitor animal movements in at least two directions. The RTLS comprises a control unit. Further, the RTLS comprises a tag associated with an animal. In addition, the RTLS also comprises at least three transceivers configured to detect signals emitted by the tag, and communicate information with the control unit. The control unit is configured to determine arrival time of the animal to the holding area via the tag and/or determine animal movement via the tag. Also, the control unit is configured to identify the animal via the tag of the animal. Furthermore, the control unit is configured to monitor, while the animal remains in the holding area, a waiting time that has passed since the animal arrived to the holding area and/or animal movements of the animal in the at least two directions. Additionally, the control unit is configured to compare the monitored waiting time and/or animal movements with a respective reference threshold. The control unit is furthermore configured to trigger an action, when the monitored waiting time, or animal movement exceeds the respective reference threshold.

In a first implementation of the holding area according to the first aspect, the control unit is configured to: monitor behaviour of the animal while remaining in the holding area, via a three Dimensional (3D)-accelerometer of the tag; store the monitored animal behaviour in a database; analyse the monitored animal behaviour; and proactively trigger the action, when the animal approaches the holding area, based on the analysed animal behaviour.

In a second implementation of the holding area according to the first aspect, or the first implementation thereof, the control unit is configured to trigger the action of disabling passage through an entrance to the milking parlour for other animals than the identified animal.

In a third implementation of the holding area according to the first aspect, or any implementation thereof, the control unit is configured to trigger the action of disable passage through an entrance to the holding area for other animals than the identified animal.

In a fourth implementation of the holding area according to the first aspect, or any implementation thereof, the control unit is configured to trigger the action of notifying a farmer of the farm.

In a fifth implementation of the holding area according to the first aspect, or any implementation thereof, the control unit is configured to determine a moment in time, when the identified animal leaves the holding area through the entrance of the milking parlour. Also, the control unit is configured to calculate a time difference between the determined arrival time of the animal to the holding area, and the determined moment in time, when the animal leaves the holding area. The control unit is also configured to rank the identified animal, based on the calculated time difference.

In a sixth implementation of the holding area according to the first aspect, or any implementation thereof, the control unit is configured to categorise the animal as low ranked, when the monitored waiting time exceeds the reference time limit.

In a seventh implementation of the holding area according to the first aspect, or any implementation thereof, the control unit is configured to order a gate to open into an area of a low ranked animal group, upon approach of the low ranked animal, thereby forcing the low ranked animal to change animal groups.

According to a second aspect of the invention, this objective is achieved by a method executed in a holding area arranged at a milking parlour of a farm. A RTLS is arranged at the holding area, and is configured to monitor animal movements in at least two directions. The RTLS comprises a control unit. Further, the RTLS also comprises a tag associated with an animal. The RTLS in addition comprises at least three transceivers. The transceivers are configured to detect signals emitted by the tag, and communicate information with the control unit. The method comprises the steps of determining arrival time of the animal to the holding area via the tag and/or animal movement via the tag. The method also comprises identifying the animal via the tag of the animal. Furthermore, the method comprises monitoring, while the animal remains in the holding area, a waiting time that has passed since the animal arrived to the holding area and/or animal movements of the animal in the at least two directions. The method in addition comprises comparing the monitored waiting time and/or animal movements with a respective reference threshold. Additionally, the method also comprises triggering an action, when the monitored waiting time, and/or animal movements exceeds the respective reference threshold.

In a first implementation of the method according to the second aspect, the method comprises monitoring behaviour of the animal while remaining in the holding area, via a 3D-accelerometer in the tag. Further, the method also comprises storing the monitored animal behaviour in a database. The method in addition comprises analysing the monitored animal behaviour. Also, the method comprises triggering the action proactively, when the animal approaches the holding area, based on the analysed animal behaviour.

In a second implementation of the method according to the second aspect, or the first implementation thereof, the method also comprises triggering the action of disabling passage through an entrance to the milking parlour for other animals than the identified animal.

In a third implementation of the method according to the second aspect, or any implementation thereof, the method comprises triggering the action of disable passage through an entrance to the holding area for other animals.

In a fourth implementation of the method according to the second aspect, or any implementation thereof, the method comprises triggering the action of notifying a farmer of the farm.

In a fifth implementation of the method according to the second aspect, or any implementation thereof, the method comprises determining a moment in time, when the animal leaves the holding area through the entrance of the milking parlour. Also, the method comprises calculating a time difference between the determined arrival time of the animal to the holding area, and the determined moment in time, when the animal leaves the holding area. The method in addition also comprises ranking the identified animal, based on the calculated time difference.

In a sixth implementation of the method according to the second aspect, or any implementation thereof, the method comprises categorising the animal as low ranked when the monitored waiting time exceeds the reference time limit.

In a seventh implementation of the method according to the second aspect, or any implementation thereof, the method comprises ordering a gate to open into an area of a low ranked animal group, upon approach of the low ranked animal, thereby forcing the low ranked animal to change animal groups.

According to a third aspect of the invention, this objective is achieved by a computer program comprising instructions which, when the computer program is executed by the control unit according to the first aspect, or any implementation thereof, cause the control unit to carry out the method according to the second aspect, or any implementation thereof.

Thanks to the described aspects, by determining time and/or movements of the animal within the holding area and compare it with a threshold limit, an appropriate action may be triggered for facilitating a smooth transition of the animal through the holding area to the milking parlour. Thereby, overstaying of the animal in the holding area may be avoided, leading to healthier animals at the farm, and increased milk yield.

Other advantages and additional novel features will become apparent from the subsequent detailed description.

### FIGURES

Embodiments of the invention will now be described in further detail with reference to the accompanying figures, in which:

FIG. 1A illustrates an example of a milking parlour and a waiting area, according to an embodiment of the invention;

FIG. 1B illustrates an example of a milking parlour and a waiting area, according to an embodiment of the invention;

FIG. 2 illustrates an example of Real-Time Location System, according to an embodiment of the invention;

FIG. 3 illustrates an example of Real-Time Location System, according to an embodiment of the invention;

FIG. 4 illustrates a further example of a milking parlour, a waiting area, and a sorting mechanism, according to an embodiment of the invention;

FIG. 5A is a flow chart illustrating a first part of a method, according to an embodiment of the invention;

FIG. 5B is a flow chart illustrating a second part of a method, according to an embodiment of the invention;

FIG. 6 is an illustration depicting a system according to an embodiment.

### DETAILED DESCRIPTION

Embodiments of the invention described herein are defined as a method, and a holding area, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

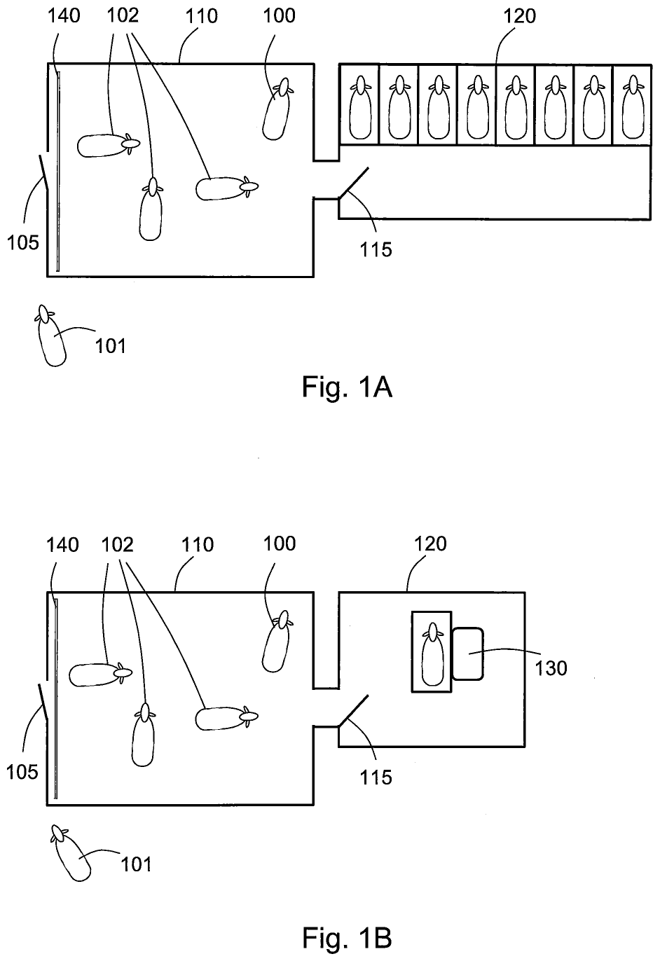

FIG. 1A illustrates a schematic scenario of a farm, as regarded from an above perspective. The farm comprises a holding area 110 and an adjacent milking parlour 120, with an entrance 115 in between. The holding area 110, which may sometimes also be referred to as waiting area, holding pen, etc., is used to hold animals 100, 101, 102 waiting to be milked.

A holding area external animal 101 is allowed to enter the holding area 110 through an entrance 105. In some embodiments, a predetermined number of animals 100, 101, 102 may be allowed to enter the holding area 110, where after the entrance 105 to the holding area 110 may be closed.

“Animal” may be any arbitrary type of domesticated female milk producing animal such as e.g. cow, goat, sheep, camel, dairy buffalo, yak, etc.

The milking parlour 120 may comprise a stanchion, a milking robot, a rotary milking platform, etc. FIG. 1B illustrates a holding area 110 and an adjacent milking parlour 120, where the milking parlour 120 comprises a milking robot 130.

The size of the holding area 110 may be adjusted by means of a moveable crowd gate 140 in some embodiments, arranged to be moveable towards and away from the entrance 115 to the milking parlour 120. When the crowd gate 140 is moved towards the entrance 115 to the milking parlour 120, the size of the holding area 110 occupied by the animals 100, 102 is decreased, encouraging the animals 100, 102 to enter the milking parlour 120.

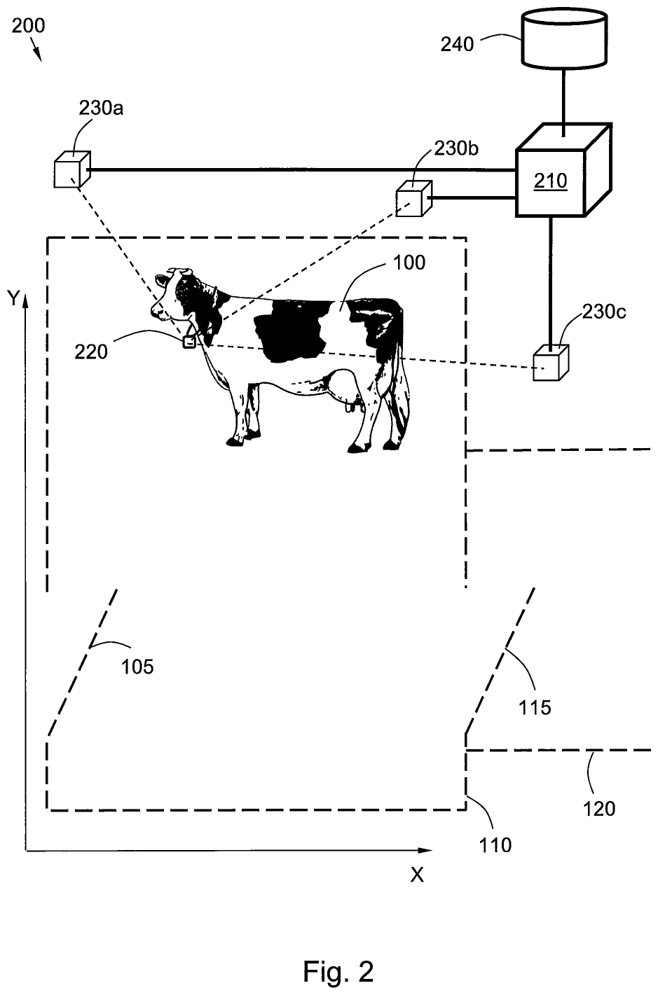

FIG. 2 schematically illustrates a holding area 110 and a Real-Time Location System (RTLS) 200 as regarded from an above perspective, according to an embodiment. The RTLS 200 comprises a control unit 210.

In the illustrated embodiment, the animal 100 has a tag 220 attached to a body part of the animal 100, such as e.g. the head of the animal 100. The tag 220 may comprise information uniquely identifying the animal 100, i.e. an identity reference such as a locally or globally unique number, name, and/or code, etc.

The tag 220 may in some embodiments also comprise a device for determining activity of the animal 100, such as e.g. a 3-Dimentional (3D) accelerometer, a pedometer, a pulse meter, a blood pressure monitoring device, a thermometer for determining body temperature of the animal 100, etc.

The optional 3D accelerometer of the tag 220 may perform high frequency recordings of biaxial and/or tri-axial acceleration, which allows for discrimination of behavioural patterns like determining whether the animal 100 is standing or laying down, or is riding another animal (due to oestrous influences) for example. The 3D accelerometer, which also may be referred to as a 3-axis accelerometer, comprises three separate internal accelerometers mounted orthogonally in relation to each other, allowing analysation of separate components of complex accelerations. Each accelerometer is an electromechanical device used to measure acceleration forces. Such forces may be static, like the continuous force of gravity, or dynamic to sense movement and/or vibrations of the animal 100. Acceleration is the measurement of the change in velocity, or speed, divided by time. For example, the animal 100 accelerating from a standstill to 10 km/h in six seconds is determined to have an acceleration of 1,67 km/h per second (10 divided by 6).

In another example, the dynamic accelerometer may measure gravitational pull to determine the angle at which the tag 220 (and thereby the body part upon which the tag 220 is arranged on the animal 100) is tilted with respect to the centre of the Earth. By sensing the amount of acceleration, the control unit 210 may analyse how the animal 100 is moving and determine for example if the animal 100 is laying down, or mounting another animal 101.

The tag 220 may comprise a transponder, comprising an identity reference of the animal 100. The tag 220 may emit wireless signals which may be received by the control unit 110 via a number of transceivers 230a, 230b, 230c, such as typically at least three transceivers 230a, 230b, 230c.

The wireless signals may be transmitted between the tag 220 and the wireless signal transceivers 230a, 230b, 230c via any convenient wireless communication technology such as Ultra-Wide Band (UWB), Bluetooth (BT), Wireless Universal Serial Bus (Wireless USB), Radio-Frequency Identification (RFID), Wi-Fi, etc.; hereby the location of an animal 100 may be determined.

The control unit 210 may determine position, identity and/or activity of the animal 100, based on signals emitted by the tag 220. The location of the tag 220 (and thereby also of the animal 100) may be made e.g. via triangulation or trilateration in at least two directions, e.g. two perpendicular directions such as X and Y. In some embodiments, it may also be determined whether the animal 100 is laying down or standing up, e.g. based on accelerometer measurements. Further, the control unit 210 may keep track of the animal 100 (location, identity, and/or activity) and possibly all animals 100, 101, 102 of the herd, in a database 240, optionally with a time stamp of each recording. The collected information may then be analysed by the control unit 210 and various behavioural patterns may be detected, such as e.g. ranking of the animal 100; and/or it may be detected that the animal 100 easily get stressed when a certain other animal 101, 102 enters the holding area 110; or that the animal 100 requires to be alone in the holding area 110 in order to relax and enter the milking parlour 120, etc.

These detected behavioural pattern of the animal 100 may then be used to implement regulations which may be distinct for each animal 100, 101, 102 of the herd. For example, the entrance 105 to the holding area 110 may be locked for entrance of other animals 101 when a certain, in particular sensitive animal 100 is detected within the holding area 110, in some embodiments.

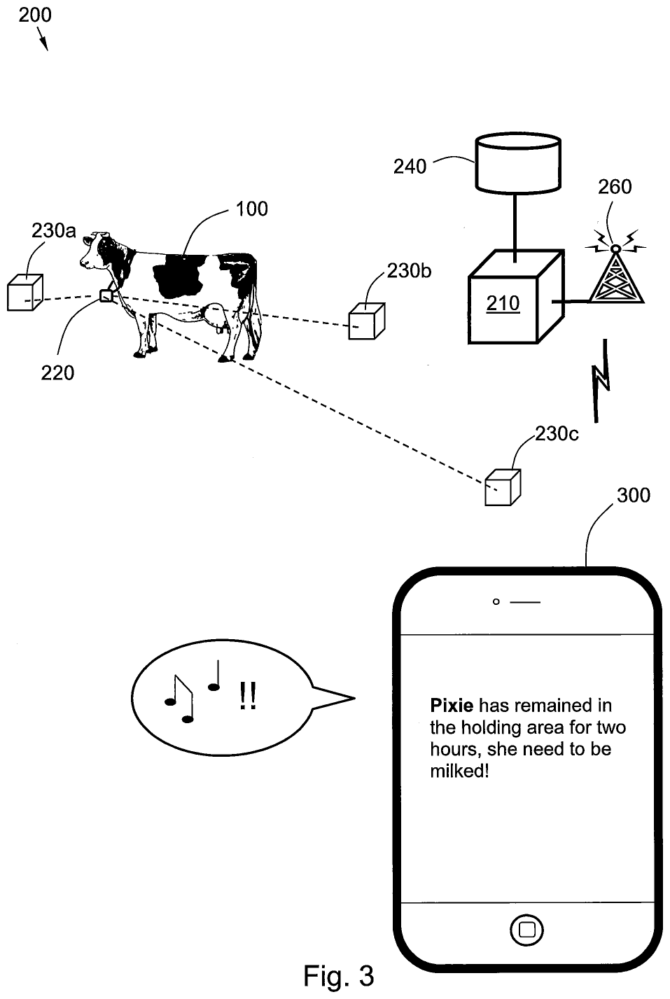

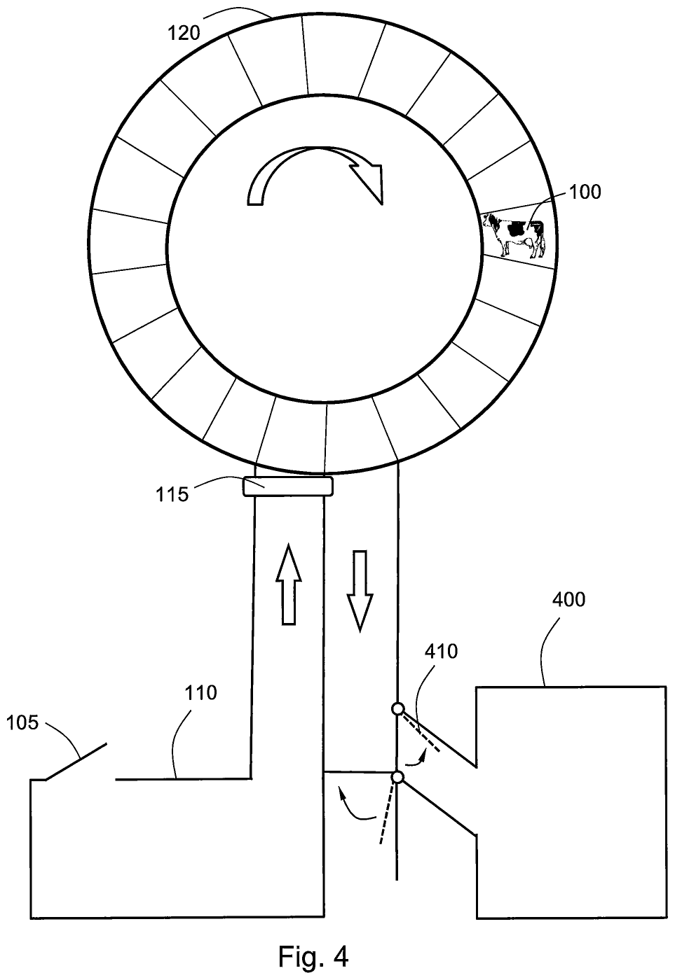

FIG. 3 also schematically illustrates a holding area 110 and a RTLS 200 as regarded from an above perspective, according to an embodiment, similar to the embodiment of FIG. 2. The RTLS 200 comprises a control unit 210, connected to, or comprising, a transceiver 260.

By detecting when the animal 100 enters the holding area 110, the animal 100 may be monitored by the control unit 210 via the tag 220 and the wireless signal transceivers 230a, 230b, 230c. When the control unit 210 detect that the animal 100 has remained in the holding area 110 for more than a predetermined or configurable reference time limit, a measure or action is triggered in order to avoid that the animal 100 remains too long in the holding area 110. To remain too long in the holding area 110 in this context means remaining there for a longer time period than the reference time limit. An example of such measure or action may be to send an alert to a communication device 300 of the farmer, or possibly some other responsible person. The expression “farmer” is to be understood in broad sense and may include any person related to, or associated with the farm and/or the agricultural activity thereon. The communication device 300 may be e.g. a cellular telephone, a computer device, a smart phone, intelligent glasses or other wearable communication devices, etc. Alternatively, or additionally, the communication device 300 may be a one-way communication device, i.e. enabling communication from the control unit 210 to the farmer, such as a loudspeaker, a light emitting device, etc.

Another measure/action may be to disable passage through an entrance 115 to the milking parlour 120 for other animals 102 than the identified animal 100. Yet an example of a measure/action may be to disable passage through an entrance 105 to the holding area 110 for other animals 101 than the identified animal 100.

In some embodiments, movements of the animal 100 may be continuously tracked while the animal 100 remains in the holding area 110, via the tag 220 of the animal 100. By determining the position of the tag 220/animal 100, and associate it with a moment in time, the movement pattern of the animal 100, and the speed of the movements may be determined by the control unit 210. An animal 100 having an abnormal moving pattern may be categorised as an exceptional animal, requiring special treatment or measures when situated in the holding area 110, such as being alone in the holding area 110, or with no more than a limited amount of other animals 101, 102, or without a certain individual other animal 101, 102.

“Exception animal” within the present context is to be interpreted in broad sense. Some examples of an exception animal 100 may be an animal in heat (which may be detected e.g. by noticing increased movement pattern;); an animal suspected to be ill (which may be detected e.g. by noticing decreased movement pattern); and/or an animal wearing a transponder or sensor which is malfunctioning (which may be detected e.g. by noticing irrational/impossible sensor values), for example. Other examples of an “exceptional animal” may be an animal sorted in the wrong group, or an animal known to be violent, for example.

Some additional measures/actions may be to activate or intensify the movements of a moveable crowd gate for forcing the animal 100 to move into the milking parlour 120.

FIG. 4 schematically illustrates a holding area 110 and an adjacent milking parlour 120. The milking parlour 120 in this example comprises a rotary parlour.

In some embodiments, a ranking mechanism may automatically estimate ranking of the animal 100, based on the time period the animal 100 has remained in the holding area 110. The ranking mechanism may comprise determining a moment in time, when the animal 100 leaves the holding area 110 through the entrance 115 of the milking parlour 120; and thereafter calculate a time difference between the arrival time of the animal 100 to the holding area 110, and the moment in time, when the animal 100 leaves the holding area 110. The animal 100 may then be ranked based on the calculated time difference.

The animal 100 may be categorised as low ranked, when the monitored waiting time exceeds the reference time limit. However, in other embodiments, several reference time limits at different levels may be established, and the animal 100 may be categorised into one rank out of a plurality of ranks, based on the comparison between the calculated time difference and the reference time limits.

In yet some embodiments, the farm, for example associated with an exit of the milking parlour 120, may comprise a gate 410, configured to be opened into an area 400 of a low ranked animal group, upon approach of the low ranked animal 100, thereby forcing the low ranked animal 100 to change animal groups.

By making an automatic sorting of low rank animals into the low ranked animal group, time is saved for the farmer, who does not have to make a manual ranking and sorting of animals.

By placing the low rank animal 100 in a low ranked animal group and subsequently let the animal 100 be milked in the low ranked animal group, it may be avoided that the animal 100 remains too long in the holding area 110, which spare her from health problems and milk yield affection.

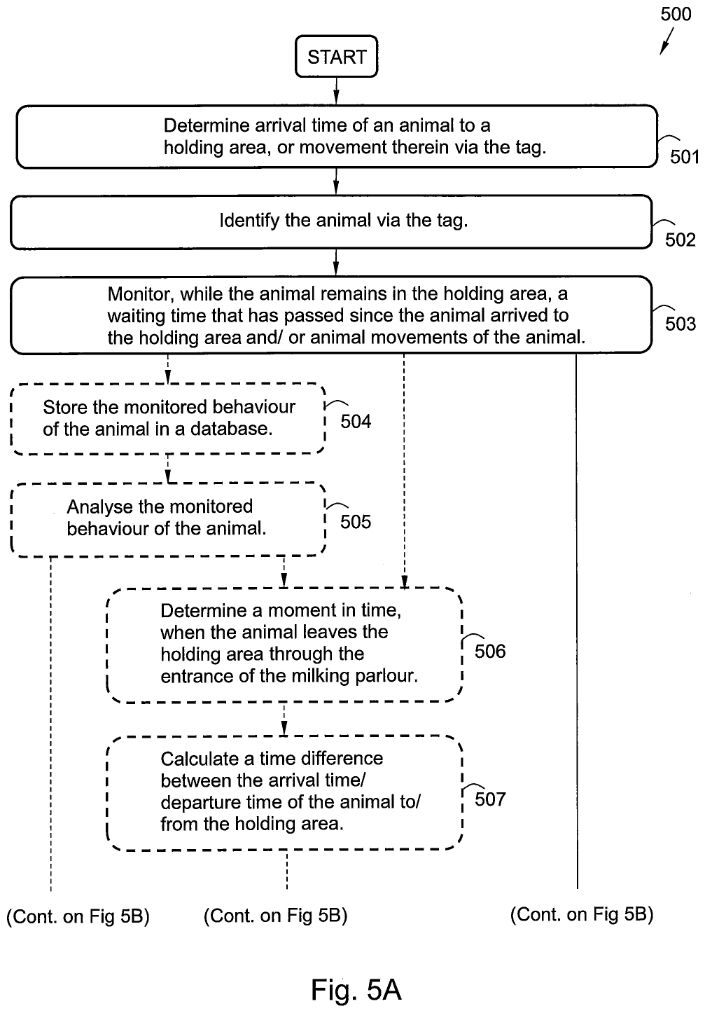

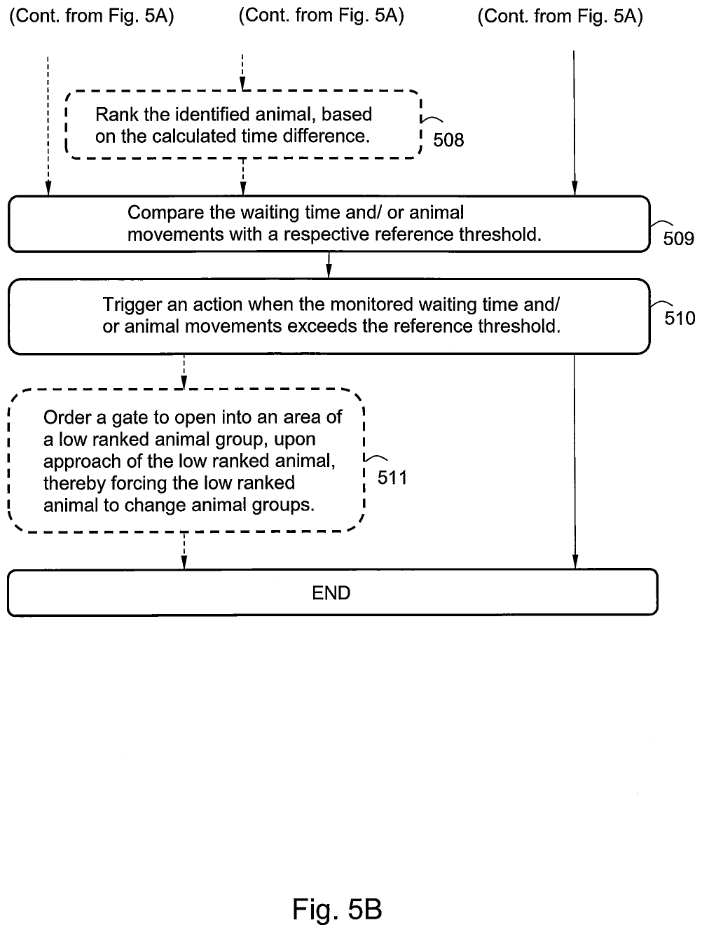

FIGS. 5A and 5B illustrates an example of a method 500 according to an embodiment. The flow chart in FIG. 5A/B shows the method 500 executed in a holding area 110 arranged at a milking parlour 120 of a farm. A Real-Time Location System (RTLS) 200 is arranged at the holding area 110, and is configured to monitor animal movements in at least two directions, such as X and/or Y, approximately situated in the same plane. The RTLS 200 comprises a control unit 210. Further, the RTLS 200 comprises a tag 220 associated with an animal 100. Additionally, the RTLS 200 comprises at least three transceivers 230a, 230b, 230c, which are configured to detect signals emitted by the tag 220 of the animal 100, and communicate information with the control unit 210, over a wired or wireless communication interface.

In order to correctly perform the method 500, a number of method steps 501-511 may be comprised. However, some of these steps 501-511 may be performed solely in some alternative embodiments, like e.g. steps 504-508 and/or 511. Further, the described steps 501-511 may be performed in a somewhat different chronological order than the numbering suggests; step 502 may for example be performed before, or simultaneously with step 501. The method 500 may comprise the subsequent steps:

Step 501 comprises determining arrival time of the animal 100 to the holding area 110, via the tag 220 and/or animal movement, via the tag 220.

The arrival time of the animal 100 may be determined by receiving a wireless signal emitted by the tag 220 via at least one of the transceivers 230a, 230b, 230c. The control unit 210 may then determine an arrival time of the animal 100, assisted by a time measuring functionality such as a clock, chronometer, chronograph, etc., when the wireless signal of the tag 220 is perceived by the transceiver 230a, 230b, 230c.

Step 502 comprises identifying the animal 100 via the tag 220 of the animal 100.

The tag 220 may for example comprise a memory on which a unique identity reference is stored and may be retrieved and provided to the control unit 210.

Step 503 comprises monitoring, while the animal 100 remains in the holding area 110, a waiting time that has passed since the animal 100 arrived to the holding area 110 and/or animal movements of the animal 100 in the at least two directions.

The monitoring thus may comprise determining whether the animal 100 still remains in the holding area 110, and detecting when the animal 100 leaves the holding area 110 for entering the milking parlour 120, based on the wireless signal emitted by the tag 220, as perceived by any one of the transceivers 230a, 230b, 230c.

Further, or alternatively, the control unit 210 may monitor movements of the animal 100 within the holding area 110, e.g. by determining position in the two directions at different moments in time and interpolate the passage way between the determined positions. Thereby, also the speed of the animal 100 may be determined; and/or the accumulated passed distance since arriving to the holding area 110 may be calculated.

The animal 100 may be categorised as low ranked when the monitored 503 waiting time exceeds the reference time limit, in some embodiments.

The monitoring may in some embodiments also, or alternatively, comprise monitoring behaviour of the animal 100 while remaining in the holding area 110, via a 3D-accelerometer in the tag 220. It may thereby be determined whether the animal 100 has been laying down in the holding area 110, or been jumping or shaking the head, for example.

Step 504, which is an optional part of the method 500, may be performed/regarded as part of the method 500 in some embodiments, comprises storing the monitored 503 animal behaviour in a database 240, associated with the identity reference of the animal 100.

Thereby, monitored 503 animal behaviour may be stored for later analysis of the behaviour by the control unit 210.

Step 505, which also is an optional part of the method 500, may be performed/regarded as part of the method 500 in some embodiments, comprises analysing the monitored 503 animal behaviour.

The monitored 503 animal behaviour may be extracted from the database 240.

Step 506, which also is an optional part of the method 500, may be performed/regarded as part of the method 500 in some embodiments, comprises determining a moment in time, when the animal 100 leaves the holding area 110 through the entrance 115 of the milking parlour 120.

The moment in time that the animal 100 leaves the holding area 110 may be determined via the transceivers 230a, 230b, 230c, upon detection of the signal emitted by the tag 220, and determination of the position of the animal 100.

Step 507, which also is an optional part of the method 500, may be performed/regarded as part of the method 500 in some embodiments wherein step 506 has been performed, comprises calculating a time difference between the determined 501 arrival time of the animal 100 to the holding area 110, and the determined 506 moment in time, when the animal 100 leaves the holding area 110.

Step 508, which also is an optional part of the method 500, may be performed/regarded as part of the method 500 in some embodiments wherein step 507 has been performed, comprises ranking the identified 502 animal 100, based on the calculated 507 time difference.

Thereby, the rank of the animal 100 may be estimated, and/or a low rank animal 100 may be identified, without involving manual inspection by the farmer, thereby relieving him/her from a tedious workload.

Step 509 comprises comparing the monitored 503 waiting time and/or animal movements with a respective reference threshold.

The reference threshold may comprise a predetermined or configurable threshold time limit when the monitored 503 waiting time is compared with it. The threshold time limit may be different for different animal races, for different herds, for different individual animals, etc.

The reference threshold may comprise a predetermined or configurable threshold distance and/or amount of activity performed by the animal 100.

Step 510 comprises triggering an action, when the monitored waiting time, and/or animal movements exceeds the respective reference threshold.

In some embodiments, the action may be triggered proactively, when the animal 100 approaches the holding area 110, based on the analysed 505 animal behaviour.

The triggered action may comprise disabling passage through an entrance 115 to the milking parlour 120 for other animals 102 than the identified animal 100, in some embodiments. Thereby, only the herein discussed animal 100 may enter the entrance 115 to the milking parlour 120, while other animals 101 trying to pass, are blocked from entering the entrance 115. Thereby, the animal 100 may spend less time in the holding area 110, leading to better health and increased milk yield.

The triggered action may optionally comprise disabling passage through an entrance 105 to the holding area 110 for other animals 101. Thereby, other animals 101, 102 may be stopped from entering the holding area 110, thereby giving the animal 100 more space in the holding area 110, and reducing cognitive stress of the animal 100, which may lead to less stress for the animal 100, and less waiting time in the holding area 110, leading to better health and increased milk yield.

The triggered action may in some embodiments comprise notifying a farmer of the farm, e.g. by transmitting an alert to a communication device 300 of the farmer. The farmer may then take appropriate measures to diminish the waiting time of the animal 100 in the holding area 110.

Some or all of these triggered actions may be combined in some embodiments, for enhanced effect.

Step 511, which is an optional part of the method 500, may be performed/regarded as part of the method 500 in some embodiments, comprises ordering a gate 410 to open into an area 400 of a low ranked animal group, upon approach of the low ranked animal 100, thereby forcing the low ranked animal 100 to change animal groups.

Thereby, animals 100, 101, 102 at the farm may be ranked and distributed into animal groups based on estimated rank, without manual interaction of the farmer. Thus, time and work of the farmer is saved, while ranking and sorting of the animals 100, 101, 102 is made without molesting the farmer, who instead may focus on other working tasks.

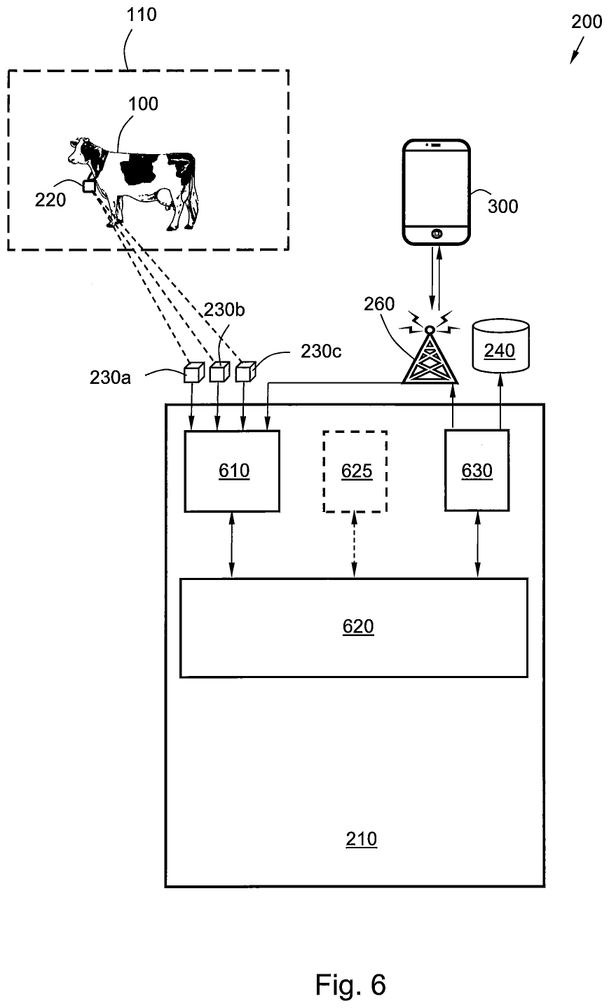

FIG. 6 illustrates holding area 110 arranged at a milking parlour 120 of a farm. A Real-Time Location System (RTLS) 200 is arranged at the holding area 110, and is configured to monitor animal movements in at least two directions, e.g. two perpendicular directions such as X and Y and/or coordinates in a Euclidian plane. The RTLS 200 comprises a control unit 210. Further, the RTLS 200 also comprises a tag 220 associated with an animal 100, i.e. a specific animal 100. In addition, the RTLS 200 comprises at least three transceivers 230a, 230b, 230c, configured to detect signals emitted by the tag 220, and to communicate information with the control unit 210.

The RTLS 200 may perform at least some of the previously described steps 501-511 according to the method 500 described above and illustrated in FIGS. 5A-5B.

The control unit 210 is configured to determine arrival time of the animal 100 to the holding area 110 via the tag 220 and/or determine animal movement via the tag 220. Further, the control unit 210 is additionally configured to identify the animal 100 via the tag 220 of the animal 100. Also, the control unit 210 is configured to monitor, while the animal 100 remains in the holding area 110, a waiting time that has passed since the animal 100 arrived to the holding area 110 and/or animal movements of the animal 100 in the at least two directions. The control unit 210 is furthermore configured to compare the monitored waiting time and/or animal movements with a respective reference threshold. In addition, the control unit 210 is configured to trigger an action, when the monitored waiting time, or animal movement exceeds the respective reference threshold.

The control unit 210 may in some embodiments be configured to compare monitor behaviour of the animal 100 while remaining in the holding area 110, via a 3D-accelerometer of the tag 220. Further, the control unit 210 may be configured to store the monitored animal behaviour in a database 240. The database 240 may be comprised in the RTLS 200. The control unit 210 may also be configured to analyse the monitored animal behaviour. Also, the control unit 210 may be configured to proactively trigger the action, when the animal 100 approaches the holding area 110, based on the analysed animal behaviour.

In some embodiments, the control unit 210 may be configured to trigger the action of disabling passage through an entrance 115 to the milking parlour 120 for other animals 102 than the identified animal 100.

The control unit 210 may furthermore be configured to trigger the action of disable passage through an entrance 105 to the holding area 110 for other animals 101 than the identified animal 100.

Also, the control unit 210 may be configured to trigger the action of notifying a farmer, e.g. by generating and transmitting an alert message to a communication device 300 of the farmer, via a transceiver 260.

Furthermore, the control unit 210 may be configured to determine a moment in time, when the identified animal 100 leaves the holding area 110 through the entrance 115 of the milking parlour 120. Also, the control unit 210 may be configured to calculate a time difference between the determined arrival time of the animal 100 to the holding area 110, and the determined moment in time, when the animal 100 leaves the holding area 110. The control unit 210 may also be configured to rank the identified animal 100, based on the calculated time difference.

The control unit 210 may optionally be configured to categorise the animal 100 as low ranked, when the monitored waiting time exceeds the reference time limit.

Further, the control unit 210 may be configured to order a gate 410 to open into an area 400 of a low ranked animal group, upon approach of the low ranked animal 100, thereby forcing the low ranked animal 100 to change animal groups.

The control unit 210 may comprise a receiver 610 configured for receiving information from the set of wireless signal receivers 230a, 230b, 230c and/or the transceiver 260.

The control unit 210 comprises a processing circuit 620 configured for performing various calculations for conducting the method 500 according to at least some of the previously described steps 501-511.

Such processing circuit 620 may comprise one or more instances of a processing circuit, i.e. a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

Furthermore, the control unit 210 may comprise a memory 625 in some embodiments. The optional memory 625 may comprise a physical device utilised to store data or programs, i.e., sequences of instructions, on a temporary or permanent basis. According to some embodiments, the memory 625 may comprise integrated circuits comprising silicon-based transistors. The memory 625 may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

Further, the control unit 210 may comprise a signal transmitter 630. The signal transmitter 630 may be configured for transmitting signals via a wired or wireless communication interface to the transceiver 260 and/or the database 240.

However, in some alternative embodiments, the RTLS 200 may comprise additional units for performing the method 500 according to the previously described method steps 501-511.

The above described steps 501-511 to be performed in the system 600 may be implemented through the one or more processing circuits 620 within the control unit 210 of the RTLS 200, together with a computer program for performing at least some of the functions of the method steps 501-511. Thus the computer program comprises instructions which, when the computer program is executed by the control unit 210, cause the control unit 210 to carry out the method 500 according to at least some of steps 501-511.

The computer program mentioned above may be provided for instance in the form of a computer-readable medium, i.e. a data carrier carrying computer program code for performing at least some of the steps 501-511 according to some embodiments when being loaded into the one or more processing circuits 620 of the control unit 210. The data carrier may be, e.g., a hard disk, a CD ROM disc, a memory stick, an optical storage device, a magnetic storage device or any other appropriate medium such as a disk or tape that may hold machine readable data in a non-transitory manner. The computer program may furthermore be provided as computer program code on a server and downloaded to the control unit 210 remotely, e.g. over an Internet or an intranet connection.

The terminology used in the description of the embodiments as illustrated in the accompanying drawings is not intended to be limiting of the described method 500; the holding area 110; the control unit 210; the computer program; the RTLS 200 and/or the computer-readable medium. Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims. The mere fact that certain measures or features are recited in mutually different dependent claims, illustrated in different figures or discussed in conjunction with different embodiments does not indicate that a combination of these measures or features cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

1. A holding area disposed at a milking parlor of a farm, the holding area comprising:
a Real-Time Location System disposed at the holding area, the Real-Time Location System being configured to monitor animal movements in at least two directions, the Real-Time Location comprising:
a controller,
a tag associated with an animal, and
at least three transceivers disposed within the holding area configured to detect signals emitted by the tag when the tag enters within the holding area, and communicate information with the controller,
wherein the controller is configured to:
determine one or more of (i) an arrival time of the animal into the holding area via the tag, and (ii) animal movement via the tag in the holding area,
identify the animal via the tag of the animal,
monitor, while the animal remains in the holding area, one or more of (i) a waiting time that has passed since the arrival time that the animal arrived to the holding area, and (ii) animal movements of the animal in the at least two directions,
compare one or more of the monitored waiting time and the animal movements with a respective reference threshold; and
trigger an action with respect to controlling access to one of the milking parlor, the holding area, and an additional grouping area, when one or more of the monitored waiting time and the animal movement exceeds the respective reference threshold.

2. The holding area according to claim 1, wherein the controller is further configured to:
monitor a behavior of the animal while the animal remains in the holding area, via a 3D-accelerometer of the tag;
store the monitored animal behavior in a database,
analyze the monitored animal behavior, and
proactively trigger the action, when the animal approaches the holding area, based on the analyzed animal behavior.

3. The holding area according to claim 1, wherein the action is disabling passage through an entrance to the milking parlor for other animals other than the identified animal.

4. The holding area according to claim 1, wherein the action is disabling passage through an entrance to the holding area for other animals other than the identified animal.

5. The holding area according to claim 1, wherein the controller is further configured to:
trigger a notification action of notifying a farmer.

6. The holding area according to claim 1, wherein the controller is further configured to:
determine a moment in time, when the identified animal leaves the holding area through an entrance of the milking parlor,
calculate a time difference between the determined arrival time of the animal to the holding area, and the determined moment in time, when the animal leaves the holding area, and
rank the identified animal, based on the calculated time difference.

7. The holding area according to claim 1, wherein the controller is further configured to:
categorize the animal as low-ranked, when the monitored waiting time exceeds the respective reference threshold.

8. The holding area according to claim 7, wherein the controller is further configured to:
order a gate to open into the additional grouping area of a low-ranked animal group, upon approach of the low-ranked animal, thereby forcing the low-ranked animal to change from a first animal group to the low-ranked animal group.

9. A method executed in a holding area disposed at a milking parlor of a farm, a Real-Time Location System being disposed at the holding area, the Real-Time Location System being configured to monitor animal movements in at least two directions, the Real-Time Location System including a controller, a tag associated with an animal, and at least three transceivers configured to detect signals emitted by the tag, and communicate information with the controller, the method comprising:
determining one or more of (i) an arrival time of the animal to the holding area via the tag, and (ii) animal movement via the tag in the holding area;
identifying the animal via the tag of the animal;
monitoring, while the animal remains in the holding area, one or more of (i) a waiting time that has passed since the animal arrived to the holding area, and (ii) animal movements of the animal in the at least two directions;
comparing one or more of the monitored waiting time and the animal movements with a respective reference threshold; and
triggering an action with respect to controlling access to one of the milking parlor and the holding area, when one or more of the monitored waiting time and the animal movements exceeds the respective reference threshold.

10. The method according to claim 9, further comprising:
monitoring a behavior of the animal while the animal remains in the holding area, via a 3D-accelerometer in the tag;
storing the monitored animal behavior in a database;
analyzing the monitored animal behavior; and
triggering the action proactively, when the animal approaches the holding area, based on the analyzed animal behavior.

11. The method according to claim 9, wherein triggering the action comprises disabling passage through an entrance to the milking parlor for other animals other than the identified animal.

12. The method according to claim 9, wherein triggering the action comprises disabling passage through an entrance to the holding area for other animals other than the identified animal.

13. The method according to claim 9, further comprising:
triggering a notification action of notifying a farmer.

14. The method according to claim 9, comprising:
determining a moment in time, when the animal leaves the holding area through an entrance of the milking parlor;
calculating a time difference between the determined arrival time of the animal to the holding area, and the determined moment in time, when the animal leaves the holding area; and
ranking the identified animal, based on the calculated time difference.

15. The method according to claim 9, wherein the animal is categorized as low-ranked when the monitored waiting time exceeds the respective reference threshold.

16. The method according to claim 15, further comprising:
ordering a gate to open into the additional grouping area of a low-ranked animal group, upon approach of the low-ranked animal, thereby forcing the low-ranked animal to change from a first animal group to the low-ranked animal group.

17. A computer program comprising instructions which, when the computer program is executed by a controller, cause the controller to carry out the method according to claim 9.

18. A method executed in a holding area disposed at a milking parlor of a farm, a Real-Time Location System being disposed at the holding area, the Real-Time Location System being configured to monitor animal movements in at least two directions, the Real-Time Location System including a controller, a tag associated with an animal, and at least three transceivers configured to detect signals emitted by the tag, and communicate information with the controller, the method comprising:
determining one or more of (i) an arrival time of the animal to the holding area via the tag, and (ii) animal movement via the tag in the holding area;
identifying the animal via the tag of the animal;
monitoring, while the animal remains in the holding area, one or more of (i) a waiting time that has passed since the animal arrived to the holding area, and (ii) animal movements of the animal in the at least two directions;
comparing one or more of the monitored waiting time with a waiting time threshold and the animal movements with one or more of a threshold distance and an amount of activity; and
triggering an action with respect to controlling access to one of the milking parlor, the holding area, and an additional grouping area, when one or more of the monitored waiting time exceeds the waiting time threshold and the animal movements exceeds the one or more of the threshold distance and the amount of activity.
